(19) United States
(12) Patent Application Publication
(10) Pub. No.: US 2023/0397675 A1
(43) Pub. Date: Dec. 14, 2023

(54) Heatable Wader Device

(71) Applicant: Frank Meyers, Wallowa, OR (US)

(72) Inventor: Frank Meyers, Wallowa, OR (US)

(21) Appl. No.: 17/840,161

(22) Filed: Jun. 14, 2022

(51) Int. Cl. A41D 13/005; H02J 7/00; H05B 3/34; A41D 13/02

(52) U.S. Cl. CPC A41D 13/0051; H02J 7/0042; H02J 7/0063; H05B 3/342; A41D 13/02

(57) ABSTRACT

A heatable wader device for heating by a plurality of electric coils includes a power box imbedded within a front of a wader. The power box has an interior where a battery is positioned within. The battery contains electric power, and the battery is rechargeable. A plurality of electric coils is connected with the battery of the power box. Each of the electric coils is produces heat at a constant temperature. The plurality of electric coils is enwraps a torso of the wader. Furthermore, the plurality of electric coils is enwraps a pair of legs of the wader. Lastly, the plurality of electric coils enwraps a pair of feet of the wader. A switch is connected with both the battery and the plurality of electric coils. The switch initiates or stops a flow of electric power to each of the electric coils.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insulated wader device and more particularly pertains to a new insulated wader device for heating by a plurality of electric coils.

### (2) Description of Related Art Including Information Disclosed Under 37 CFR 1.97 and 1.98

The prior art relates to insulated wader devices. The prior art relates to a variety of insulated wader devices configured for being liquid resistant and insulated. Known prior art lacks an insulated wader device configured for being liquid resistant and heating the user by a plurality of electric coils receiving power from a power box imbedded within the waders.

### BRIEF SUMMARY OF THE INVENTION

An embodiment of the disclosure meets the needs presented above by generally comprising a power box configured for being imbedded within a front of a wader. The power box has an interior defining a space for a variety of elements to be positioned within. A battery is positioned within the interior of the power box. The battery is configured for containing electric power, and the battery is rechargeable. A plurality of electric coils is in electric communication with the battery of the power box. Each of the electric coils is configured for producing heat at a constant temperature. The plurality of electric coils is configured for enwrapping a torso of the wader. Furthermore, the plurality of electric coils is configured for enwrapping a pair of legs of the wader. Lastly, the plurality of electric coils is configured for enwrapping a pair of feet of the wader. A switch is in electric communication with the battery and the plurality of electric coils. The switch is configured for initiating or stopping a flow of electric power to each of the electric coils.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a heatable wader device according to an embodiment of the disclosure.

FIG. 2 is a top isometric view of an embodiment of the disclosure.

FIG. 3 is a side view of an embodiment of the disclosure.

FIG. 4 is a front detail interior view of an embodiment of the disclosure.

FIG. 5 is an in-use view of an embodiment of the disclosure.

### DETAILED DESCRIPTION OF THE INVENTION

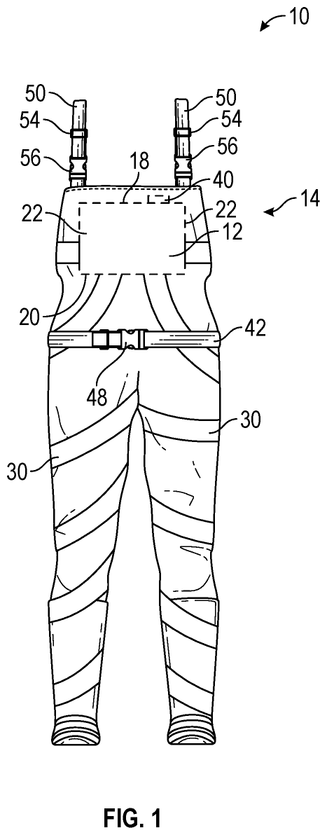

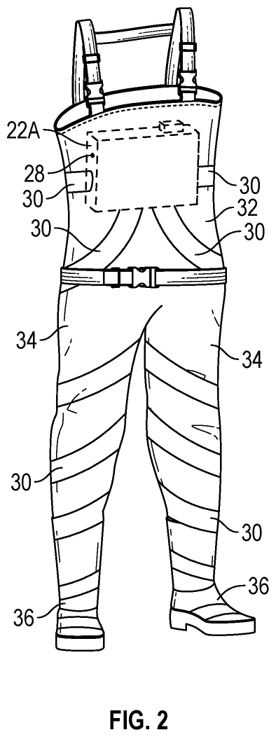

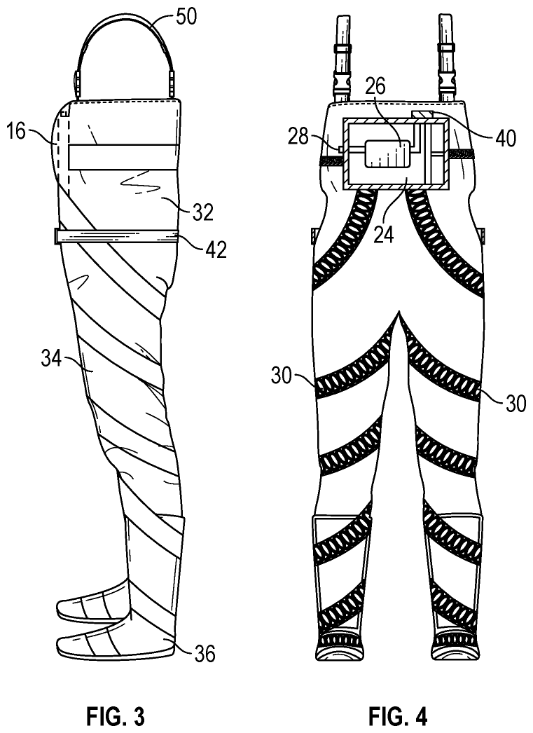

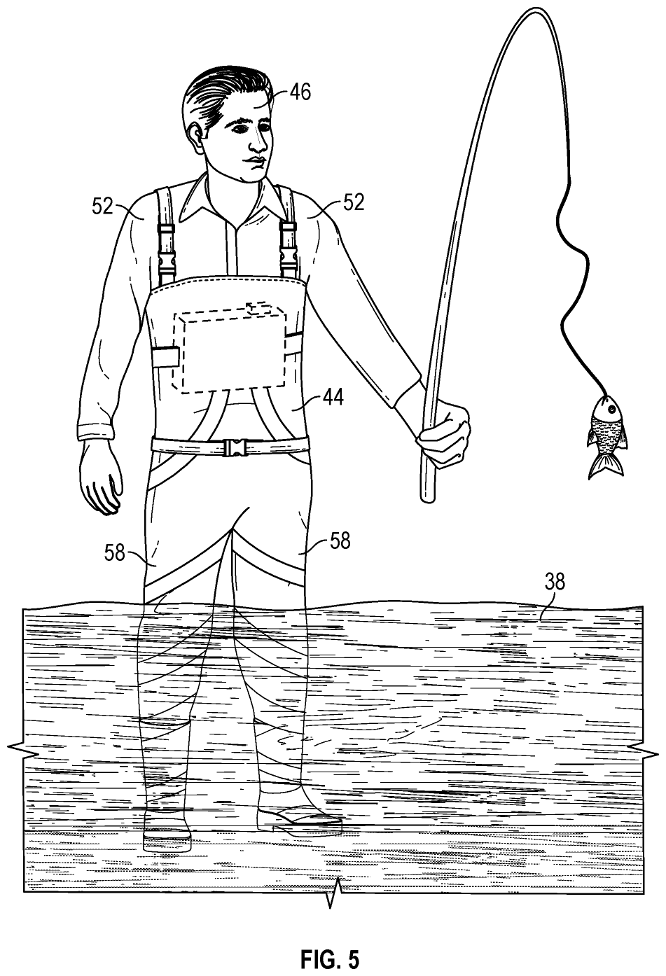

With reference now to the drawings, and in particular to FIGS. 1 through 5 thereof, a new insulated wader device embodying the principles and concepts of an embodiment of the disclosure and generally designated by the reference numeral 10 will be described.

As best illustrated in FIGS. 1 through 5, the heatable wader device 10 generally comprises a power box 12 configured for being imbedded within a front 16 of a wader 14. The power box 12 has top surface 18, a bottom surface 20, and a pair of side surfaces 22. The top 18 and bottom 20 surfaces are positioned perpendicular relative to each of the side surfaces 22. The power box 12 has an interior 24, wherein the interior 24 defines a space for a variety of elements to be positioned within. The power box 12 is configured for being liquid resistant, wherein the power box 12 is waterproof. A battery 26 is positioned within the interior 24 of the power box 12. The battery 26 is configured for containing electric power. The battery 26 is rechargeable, and the battery 26 has a port 28. The port 28 is positioned on a first side surface 22A of the pair of side surfaces 22. The port 28 is configured for nesting an input to a power cord wherein providing electric charge to the battery 26.

A plurality of electric coils 30 is in electric communication with the battery 26 of the power box 12. Each of the electric coils 30 is configured for producing heat at a constant temperature. The plurality of electric coils 30 protrudes out from a respective one of each of the side surfaces 22 of the power box 12 and from the bottom surface 20 of the power box 12. The plurality of electric coils 30 is configured for enwrapping a torso 32 of the wader 14. Furthermore, the plurality of electric coils 30 is configured for enwrapping a pair of legs 34 of the wader 14. Lastly, the plurality of electric coils 30 is configured for enwrapping a pair of feet 36 of the wader 14. The plurality of electric coils enwraps the areas of the wader 14 that will be submerged within cold water 38 when in use.

A switch 40 is in electric communication with the battery 26 and the plurality of electric coils 30. The switch 40 is positioned on the top surface 18 of the power box 12. The switch 40 is an actuator configured for initiating or stopping a flow of electric power to each of the electric coils 30 from the battery 26. Furthermore, a belt 42 is configured for enwrapping the torso 32 of the wader 14. The belt is configured for securing the torso 32 of the wader 14 to the waist 44 of the user 46. The belt 42 has a clasp fastener 48 configured for being positioned on the front 16 of the wader 14.

A pair of shoulder straps 50 is configured for being positioned on a respective one of a pair of shoulders 52 of the user 46. Each of the shoulder straps 50 has an adjustment mechanism 54 configured for adjust a length of each of the shoulder straps 50. Each of the shoulder straps 50 has a clasp fastener 56 configured for unlatching the pair of shoulder straps 50 from the pair of shoulders 52 of the user 46. The pair of shoulder straps 50 facilitates in securing the wader 14 on the user 46.

In use, the pair of legs 58 of the user 46 is inserted into a respective one of the pair of legs 34 of the wader 14. The pair of shoulder straps 50 of the wader 14 is positioned upon a respective one of the pair of shoulders 52 of the user 46. The adjustment mechanism 54 of each of the shoulder straps 50 secures the wader 14 to the pair of shoulders 52 of the user 46. The belt 42 of the wader 14 further secures the torso 32 of the wader 14 to the waist 44 of the user 46. The switch 40 of the power box 12 can be engaged with to actuate the flow of electricity from the battery 26 to the plurality of electric coils 30, wherein providing heat among the wader 14. The user 46 can be submerged within cold water 38, wherein the plurality of electric coils 30 will keep the user 46 heated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heatable wader device configured for integrating a plurality of electric coils within a wader, the heatable wader device comprising:
a power box configured for being imbedded within a front of a wader, said power box having an interior, said interior defining a space for a variety of elements to be positioned within;
a battery being positioned within said interior of said power box, said battery being configured for containing electric power, said battery being rechargeable;
a plurality of electric coils being in electric communication with said battery of said power box, each of said electric coils being configured for producing heat at a constant temperature, said plurality of electric coils being configured for enwrapping a torso of the wader, said plurality of electric coils being configured for enwrapping a pair of legs of the wader, said plurality of electric coils being configured for enwrapping a pair of feet of the wader; and
a switch being in electric communication with said battery and said plurality of electric coils, said switch being configured for initiating or stopping a flow of electric power to each of said electric coils from said battery.

2. The heatable wader device of claim 1, further comprising said power box having top surface and a bottom surface, said power box having a pair of side surfaces, said top and bottom surfaces being positioned perpendicular relative to each of said side surfaces.

3. The heatable wader device of claim 2, further comprising said power box configured for being liquid resistant.

4. The heatable wader device of claim 3, further comprising said battery having a port, said port being positioned on a first side surface of said pair of side surfaces, said port being configured for nesting an input to a power cord wherein providing electric charge to said battery.

5. The heatable wader device of claim 4, further comprising said plurality of electric coils protruding out from a respective one of each of said side surface of said power box and from said bottom surface of said power box.

6. The heatable wader device of claim 5, further comprising said switch being positioned on said top surface of said power box, said switch being an actuator.

7. The heatable wader device of claim 6, further comprising a belt being configured for enwrapping the torso of the wader, said belt being configured for securing the torso of the wader to the waist of the user, said belt having a clasp fastener configured for being positioned on the front of the wader.

8. The heatable wader device of claim 7, further comprising a pair of shoulder straps being configured for being positioned on a respective one of a pair of shoulders of the user, each of said shoulder straps having an adjustment mechanism configured for adjust a length of each of said shoulder straps, each of said shoulder straps having a clasp fastener.

9. A heatable wader device configured for integrating a plurality of electric coils within a wader, the heatable wader device comprising:
a power box configured for being imbedded within a front of a wader, said power box having top surface and a bottom surface, said power box having a pair of side surfaces, said top and bottom surfaces being positioned perpendicular relative to each of said side surfaces, said power box having an interior, said interior defining a space for a variety of elements to be positioned within, said power box configured for being liquid resistant;
a battery being positioned within said interior of said power box, said battery being configured for containing electric power, said battery being rechargeable, said battery having a port, said port being positioned on a first side surface of said pair of side surfaces, said port being configured for nesting an input to a power cord wherein providing electric charge to said battery;
a plurality of electric coils being in electric communication with said battery of said power box, each of said electric coils being configured for producing heat at a constant temperature, said plurality of electric coils protruding out from a respective one of each of said side surface of said power box and from said bottom surface of said power box, said plurality of electric coils being configured for enwrapping a torso of the wader, said plurality of electric coils being configured for enwrapping a pair of legs of the wader, said plurality of electric coils being configured for enwrapping a pair of feet of the wader;
a switch being in electric communication with said battery and said plurality of electric coils, said switch being positioned on said top surface of said power box, said switch being an actuator, said switch being configured for initiating or stopping a flow of electric power to each of said electric coils from said battery;
a belt being configured for enwrapping the torso of the wader, said belt being configured for securing the torso of the wader to the waist of the user, said belt having a clasp fastener configured for being positioned on the front of the wader; and
a pair of shoulder straps being configured for being positioned on a respective one of a pair of shoulders of the user, each of said shoulder straps having an adjustment mechanism configured for adjust a length of each of said shoulder straps, each of said shoulder straps having a clasp fastener.
